(19) United States
(12) Patent Application Publication
(10) Pub. No.: US 2022/0040787 A1
(43) Pub. Date: Feb. 10, 2022

(54) LASER BEAM MACHINE

(71) Applicant: Mitsubishi Electric Corporation, Tokyo (JP)

(72) Inventors: Masahiro HIRAYAMA, Tokyo (JP); Takeshi KITAGAWA, Tokyo (JP)

(73) Assignee: Mitsubishi Electric Corporation, Tokyo (JP)

(21) Appl. No.: 17/435,036

(22) PCT Filed: Apr. 25, 2019
(86) PCT No.: PCT/JP2019/017739

§ 371 Date: Aug. 31, 2021

(51) Int. Cl. B23K 26/08

(52) U.S. Cl. CPC B23K 26/0876

(57) ABSTRACT

A laser beam machine includes: a processor to machine a workpiece as the processor moves; a saddle that holds the processor, and moves the processor in a Y direction by moving in the Y direction along a guide extending in the Y direction; a cross rail on which the saddle is placed, the cross rail moving the saddle and the processor in an X direction by moving in the X direction along a guide extending in the X direction; and a bed on which the cross rail is placed via the guide extending in the X direction. The bed includes bases and beams, one of longitudinal end portions of the base is joined to a side surface of the beam, one of longitudinal end portions of the beam is joined to a side surface of the base.

### FIELD

The present invention relates to a laser beam machine that machines a workpiece with a processor that is movable.

### BACKGROUND

While causing a machining head that emits a laser beam to move at high speed, a laser beam machine, which is an example of a machine tool, cuts out various members from a workpiece at high speed with the emitted laser beam.

For example, a laser beam machine moves a machining head in an X direction and a Y direction by moving a cross rail with the machining head mounted thereon along guides provided on bases in such a way as to extend in the X direction, and moving the machining head along a guide provided on the cross rail in such a way as to extend in the Y direction. In this laser beam machine, acceleration is applied in the X direction and the Y direction while the machining head is moving, so that vibration is generated in the machining head. When this vibration reaches an eigenvalue (natural frequency) of the laser beam machine, the machining head is greatly shaken, leading to deterioration of machining accuracy. Such a laser beam machine is required to have high rigidity and a high natural frequency so as to suppress vibration caused by movement of the machining head.

In a machine tool of Patent Literature 1, a hollow cross rail has an inclined surface, and a slide mechanism for sliding a machining head is placed on the inclined surface, so that the rotation center of torsion of the cross rail is brought close to the center of gravity of a machining head mounting portion. Thus, the machine tool of Patent Literature 1 reduces the moment of inertia around the center of torsion of the cross rail, the moment of inertia being generated when the cross rail is accelerated and decelerated in a translation direction. As a result, vibration around the center of torsion of the cross rail is reduced.

### CITATION LIST

### Patent Literature

Patent Literature 1: Japanese Patent Application Laid-open No. 2000-263356

### SUMMARY

### Technical Problem

However, in the technique of Patent Literature 1 described above, side surfaces of two bases extending in parallel in the X direction are connected to each other by two coupling beams (beams) extending in parallel in the Y direction. Thus, a rectangular annular bed is formed on which the cross rail is placed. With this configuration, in the bed of Patent Literature 1 described above, the cross-sectional secondary moment of the beam serves as a value of rigidity against the torsion of the bed with respect to an acceleration in the X direction, and the cross-sectional secondary moment of the base serves as a value of rigidity against the torsion of the bed with respect to an acceleration in the Y direction. A sufficiently high value of rigidity against the torsion of the bed cannot be obtained by the cross-sectional secondary moment of the beam or the cross-sectional secondary moment of the base alone, so that the machining head greatly vibrates in the technique of Patent Literature 1 described above.

The present invention has been made in view of the above, and an object of the present invention is to obtain a laser beam machine capable of suppressing vibration of a processor that is movable and machines a workpiece, even in a case where rigidity of a base itself or rigidity of a beam itself is low.

### Solution to Problem

To solve the above problems and achieve the object a laser beam machine according to the present invention includes: a processor to machine a workpiece as the processor moves; a first movable body to hold the processor and move the processor in a first direction by moving in the first direction along a guide extending in the first direction; a second movable body on which the first movable body is placed, the second movable body moving the first movable body and the processor in a second direction by moving in the second direction along guides extending in the second direction; and a bed on which the second movable body is placed via the guides extending in the second direction. The bed includes pillar-shaped first to fourth members, one of longitudinal end portions of the first member is joined to a side surface of the second member, one of longitudinal end portions of the second member is joined to a side surface of the third member, one of longitudinal end portions of the third member is joined to a side surface of the fourth member, and one of longitudinal end portions of the fourth member is joined to a side surface of the first member.

### Advantageous Effects of Invention

A laser beam machine according to the present invention has an effect capable of suppressing vibration of a processor that is movable and machines a workpiece, even in a case where rigidity of a base itself or rigidity of a beam itself is low.

### BRIEF DESCRIPTION OF DRAWINGS

FIG. 1 is a diagram illustrating a configuration of a laser beam machine according to a first embodiment.

FIG. 2 is a perspective view of a bed included in the laser beam machine according to the first embodiment, illustrating a configuration of the bed.

FIG. 3 is a five-view drawing illustrating the configuration of the bed included in the laser beam machine according to the first embodiment.

FIG. 4 is a diagram for describing a positional relationship between bases and beams in the bed illustrated in FIG. 3.

FIG. 5 is a perspective view of a bed included in a laser beam machine according to a second embodiment, illustrating a configuration of the bed.

FIG. 6 is a five-view drawing illustrating the configuration of the bed included in the laser beam machine according to the second embodiment.

FIG. 7 is a diagram for describing a position where a base and a beam are joined in the bed illustrated in FIG. 6.

FIG. 8 is a cross-sectional view of the bed illustrated in FIG. 6, taken along line A-A.

FIG. 9 is a cross-sectional view of the bed illustrated in FIG. 6, taken along line C-C.

FIG. 10 is a perspective view of a bed included in a laser beam machine according to a third embodiment, illustrating a configuration of the bed.

FIG. 11 is a five-view drawing illustrating the configuration of the bed included in the laser beam machine according to the third embodiment.

FIG. 12 is a cross-sectional view of the bed illustrated in FIG. 11, taken along line A-A.

FIG. 13 is a cross-sectional view of the bed illustrated in FIG. 11, taken along line C-C.

### DESCRIPTION OF EMBODIMENTS

A laser beam machine according to each embodiment of the present invention will be described below in detail with reference to the drawings. Note that the present invention is not limited to the embodiments.

### First Embodiment

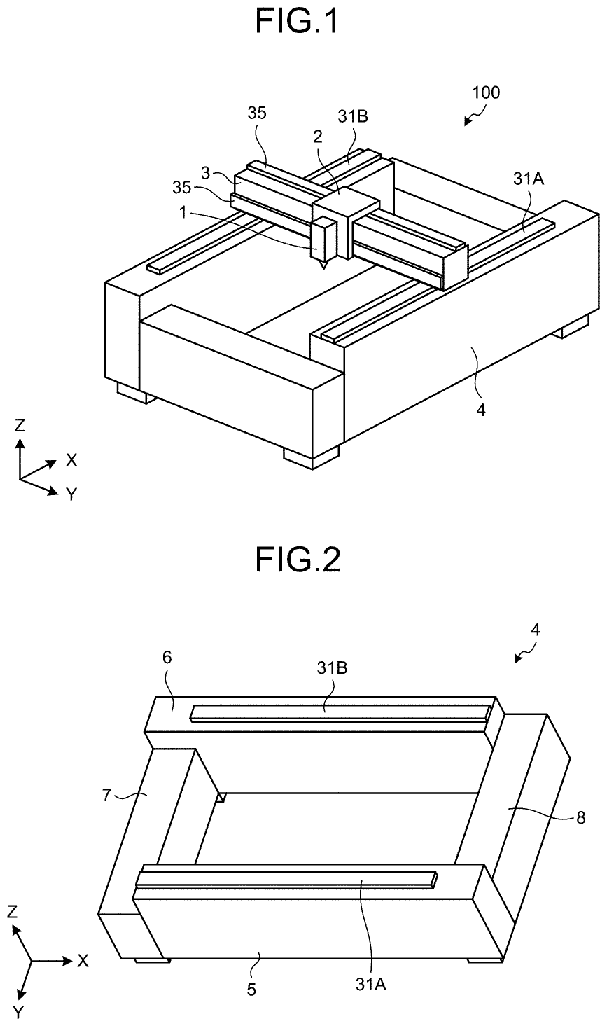

FIG. 1 is a diagram illustrating a configuration of a laser beam machine according to a first embodiment. FIG. 1 is a perspective view of a laser beam machine 100. Hereinafter, a description will be given of a case where an X-Y plane is parallel to a horizontal plane and a Z-axis direction is parallel to a vertical direction.

The laser beam machine 100 includes: a machining head 1 that irradiates a workpiece with a laser beam; a slider (not illustrated) that fixes the machining head; and a saddle 2 having a guide structure for moving the slider up and down. The laser beam machine 100 is an example of a machine tool, and the machining head 1 is an example of a processor that machines a workpiece as the machining head 1 moves.

The slider that fixes the machining head 1 is disposed between the saddle 2 and the machining head 1. The guide structure provided in the saddle 2 is a structure using a guide (not illustrated) extending in the Z-axis direction. As the slider moves in the Z-axis direction along the guide, the machining head 1 moves in the Z-axis direction.

In addition, the laser beam machine 100 includes a cross rail 3. The cross rail 3 has a guide structure (Y-axis guide 35) for moving the saddle 2, which is a first movable body, parallel to the horizontal plane (work surface). The Y-axis guide 35 is a guide extending in a Y direction. As the saddle 2 moves in the Y direction along the Y-axis guide 35, the machining head 1 moves in the Y direction.

Furthermore, the laser beam machine 100 includes a bed 4 on which the cross rail 3 is placed. The bed 4 includes columns having guide structures (X-axis guides 31A and 31B) for moving the cross rail 3, which is a second movable body, parallel to the horizontal plane and perpendicular to a direction in which the saddle 2 is moved. The columns are members of the upper side of the bed 4, and are formed integrally with the bed 4.

The X-axis guides 31A and 31B are guides extending in an X direction. As the cross rail 3 moves in the X direction along the X-axis guides 31A and 31B, the cross rail 3 and the machining head 1 move in the X direction.

The cross rail 3 is placed on the bed 4 via the X-axis guides 31A and 31B. The bed 4 includes two coupling beams (beams 7 and 8 to be described below) and two bases (bases 5 and 6 to be described below). The beams 7 and 8 are arranged in parallel to the Y direction that is a first direction. The bases 5 and 6 are arranged in parallel to the X direction that is a second direction. The bed 4 has a rectangular annular shape in which each of the bases 5 and 6 and the beams 7 and 8 serves as a side. Four legs are disposed at four corners under the bed 4, so that the bed 4 is supported by the four legs.

Note that the bed 4 and the columns may be formed separately. When the bed 4 and the columns are formed separately, the column is disposed on the upper surface of each of the bases 5 and 6. Furthermore, a reinforcing rib may be disposed inside each of the bases 5 and 6. Moreover, a reinforcing rib may be disposed inside each of the beams 7 and 8. When a reinforcing rib is disposed inside each of the bases 5 and 6, the natural frequency of the laser beam machine 100 is improved. In addition, when a reinforcing rib is disposed inside each of the beams 7 and 8, the natural frequency of the laser beam machine 100 is improved.

Next, the overall configuration of the bed 4 will be described. FIG. 2 is a perspective view of the bed included in the laser beam machine according to the first embodiment, illustrating a configuration of the bed. The bed 4 includes the bases 5 and 6 extending in the X direction and the beams 7 and 8 extending in the Y direction. The base 5 and the base 6 have the similar shape, and the beam 7 and the beam 8 have the similar shape. The bases 5 and 6 and the beams 7 and 8 are formed by use of pillar-shaped members.

The base 5, which is a first member, is joined to the beams 7 and 8. The beam 7, which is a second member, is joined to the bases 5 and 6. Furthermore, the base 6, which is a third member, is joined to the beams 7 and 8. The beam 8, which is a fourth member, is joined to the bases 5 and 6. The X-axis guide 31A is disposed on the base 5, and the X-axis guide 31B is disposed on the base 6. Each of the bases 5 and 6 and the beams 7 and 8 is provided with a single leg.

Note that FIG. 2 illustrates the bases 5 and 6 and the beams 7 and 8 such that the long sides (sides extending in the X direction) of the bases 5 and 6 are longer than the long sides (sides extending in the Y direction) of the beams 7 and 8, but the long sides of the beams 7 and 8 may be longer than the long sides of the bases 5 and 6. In addition, the long sides of the bases 5 and 6 may be equal in length to the long sides of the beams 7 and 8.

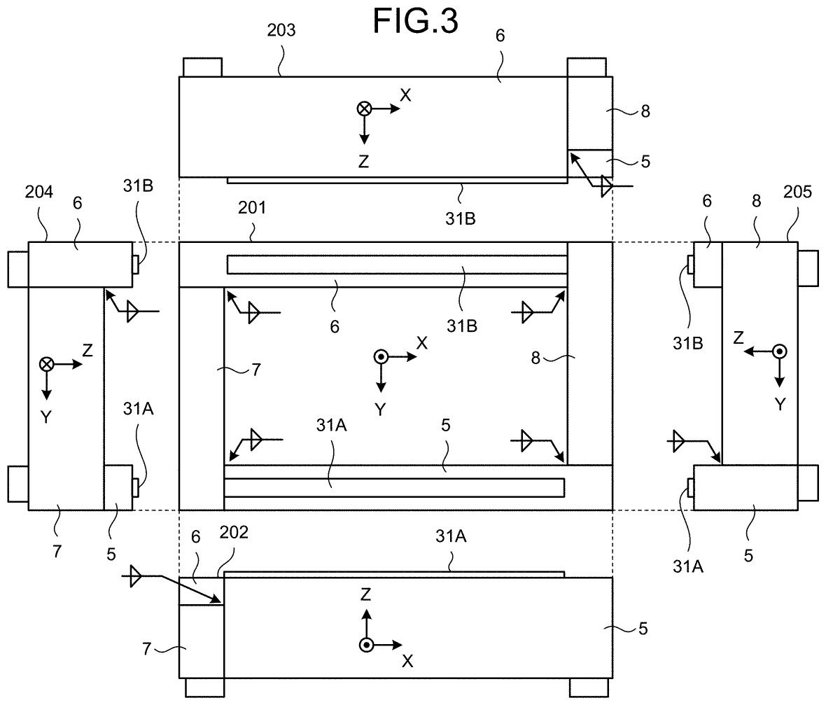

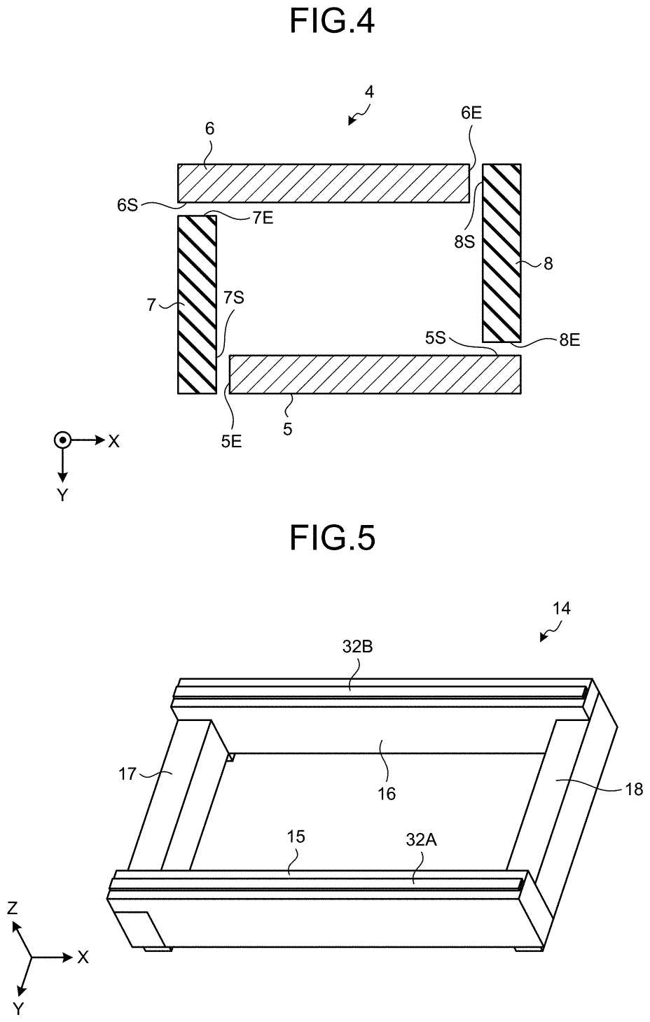

FIG. 3 is a five-view drawing illustrating the configuration of the bed included in the laser beam machine according to the first embodiment. FIG. 4 is a diagram for describing a positional relationship between the bases and the beams in the bed illustrated in FIG. 3. FIG. 3 illustrates a plan view 201, a front view 202, a rear view 203, a left side view 204, and a right side view 205 of the bed 4. FIG. 4 illustrates a cross-sectional view of the bed 4 taken along the X-Y plane. Note that in FIG. 3 and FIGS. 6 and 11 to be described below, examples of welded portions are indicated by triangle marks, but the bases and the beams may be welded at points other than the points indicated by the triangle marks.

A longitudinal front end surface 5E of the base 5 is joined to a side surface (rear end side surface 7S) of a rear end side portion of the beam 7. A longitudinal front end surface 7E of the beam 7 is joined to a side surface (rear end side surface 6S) of a rear end side portion of the base 6. A longitudinal front end surface 6E of the base 6 is joined to a side surface (rear end side surface 8S) of a rear end side portion of the beam 8. A longitudinal front end surface 8E of the beam 8 is joined to a side surface (rear end side surface 5S) of a rear end side portion of the base 5.

As described above, the front end surface of the base is joined to the side surface of one of the beams, and the rear end side portion of the side surface of the base is joined to the front end surface of the other beam. In addition, the front end surface of the beam is joined to the side surface of one of the bases, and the rear end side portion of the side surface of the beam is joined to the front end surface of the other base. That is, each member of the bases 5 and 6 and the beams 7 and 8 is joined to a side surface of one of adjacent members and the front end surface of the other adjacent member.

In the first embodiment, the front end surface 5E is one of longitudinal (axial direction) end portions of the base 5, and the front end surface 7E is one of longitudinal end portions of the beam 7. In addition, the front end surface 6E is one of longitudinal end portions of the base 6, and the front end surface 8E is one of longitudinal end portions of the beam 8.

Note that the bases 5 and 6 and the beams 7 and 8 may be joined by welding, or may be joined by other joining methods such as bolt fastening.

Here, a structure of a bed of a comparative example will be described. The bed of the comparative example includes a first base and a second base extending in an X direction, and a first beam and a second beam extending in a Y direction. In the bed of the comparative example, a front end surface of the first beam is joined to a front end side portion of a side surface of the first base, and a front end surface of the second beam is joined to a rear end side portion of the side surface of the first base. In addition, a rear end surface of the first beam is joined to a front end side portion of a side surface of the second base, and a rear end surface of the second beam is joined to a rear end side portion of the side surface of the second base. In other words, each of the first beam and the second beam is interposed between the side surface of the first base and the side surface of the second base. That is, each of the first beam and the second beam has a front end surface joined to the side surface of the first base, and has a rear end surface joined to the side surface of the second base.

In the case of such a configuration of the bed of the comparative example, torsional rigidity with respect to a direction (Y direction) in which the first beam and the second beam extend is dominant as rigidity for translation in a direction (X direction) in which the first base and the second base extend. In addition, torsional rigidity with respect to the direction in which the first base and the second base extend is dominant as rigidity for translation in the direction in which the first beam and the second beam extend. That is, in the case of the configuration of the bed of the comparative example, although the first base, the second base, the first beam, and the second beam are joined and integrated, rigidity for translation of each two components is independent of each other.

Meanwhile, in the bed 4 in the present embodiment, the front end surface 5E of the front end portion of the base 5 is joined to the rear end side surface 7S of the beam 7, and the front end surface 6E of the front end portion of the base 6 is joined to the rear end side surface 8S of the beam 8. In addition, in the bed 4, the front end surface 7E of the front end portion of the beam 7 is joined to the rear end side surface 6S of the base 6, and the front end surface 8E of the front end portion of the beam 8 is joined to the rear end side surface 5S of the base 5.

As a result, the rigidity of the entire bed 4 for translation in the longitudinal directions of the bases 5 and 6 includes, as combined rigidity, not only torsional rigidity in the longitudinal directions of the beams 7 and 8 but also rigidity for translation in the longitudinal directions of the bases 5 and 6. As a result, the bed 4 according to the present embodiment has higher rigidity of the entire bed 4 for translation in the longitudinal directions of the bases 5 and 6 than the bed of the comparative example.

Similarly, the rigidity of the entire bed 4 for translation in the longitudinal directions of the beams 7 and 8 includes, as combined rigidity, not only torsional rigidity in the longitudinal directions of the bases 5 and 6 but also rigidity for translation in the longitudinal directions of the beams 7 and 8. As a result, the bed 4 according to the present embodiment has higher rigidity of the entire bed 4 for translation in the longitudinal directions of the beams 7 and 8 than the bed of the comparative example.

As described above, the cross-sectional secondary moments of the bases 5 and 6 and the beams 7 and 8 are combined to serve as a value of rigidity against torsion in the laser beam machine 100. Thus, the value of the cross-sectional secondary moment for the laser beam machine 100 is larger than that for the bed of the comparative example. This achieves, in the laser beam machine 100, improvement in the cross-sectional secondary moment of the bed 4 in the direction (X direction) in which the cross rail 3 is moved and in the direction (Y direction) in which the saddle 2 is moved, so that the natural frequency of the bed 4 is improved. Thus, even when the rigidity of the bases 5 and 6 themselves or the rigidity of the beams 7 and 8 themselves is low in the laser beam machine 100, the vibration resistance characteristics of the entire laser beam machine 100 are improved, so that vibration of the machining head 1 can be suppressed. As a result, the laser beam machine 100 can machine a workpiece with high accuracy.

Note that the machine tool is not limited to the laser beam machine 100. The machine tool may be any device as long as the device includes a processor that is movable and machines a workpiece. A turret punch press can be cited as another example of the machine tool. When the machine tool is a turret punch press, a die corresponds to the processor.

As described above, in the bed 4 of the first embodiment, the front end portion of the base 5 is joined to the rear end side portion of the side surface of the beam 7, the front end portion of the beam 7 is joined to the rear end side portion of the side surface of the base 6, the front end portion of the base 6 is joined to the rear end side portion of the side surface of the beam 8, and the front end portion of the beam 8 is joined to the rear end side portion of the side surface of the base 5. As a result, a combination of torsional rigidity in the longitudinal directions of the beams 7 and 8 and rigidity for translation in the longitudinal directions of the bases 5 and 6 serves as the rigidity of the bed 4 for translation in the longitudinal directions of the bases 5 and 6. In addition, a combination of torsional rigidity in the longitudinal directions of the bases 5 and 6 and rigidity for translation in the longitudinal directions of the beams 7 and 8 serves as the rigidity of the bed 4 for translation in the longitudinal directions of the beams 7 and 8. Therefore, even if acceleration in the X direction or the Y direction is produced in the machining head 1 when the cross rail 3 or the saddle 2 moves, vibration due to torsion of the bases 5 and 6 and the beams 7 and 8 can be reduced, so that vibration of the machining head 1 can be suppressed.

### Second Embodiment

Next, a second embodiment of the present invention will be described with reference to FIGS. 5 to 9. In the second embodiment, a front end portion of a base is placed on the upper surface of a beam, so that an X-axis guide is extended to the beam side.

FIG. 5 is a perspective view of a bed included in a laser beam machine according to the second embodiment, illustrating a configuration of the bed. A bed 14 includes bases 15 and 16 extending in an X direction and beams 17 and 18 extending in a Y direction.

The beams 17 and 18 have the similar shape as the beams 7 and 8. The beam 17 is disposed at the similar position as the beam 7, and the beam 18 is disposed at the similar position as the beam 8. The base 15 is disposed at the similar position as the base 5, and the base 16 is disposed at the similar position as the base 6. That is, the bed 14 has a rectangular annular shape in which each of the bases 15 and 16 and the beams 17 and 18 serves as a side. Specifically, the base 15 is joined to the beams 17 and 18, and the beam 17 is joined to the bases 15 and 16. In addition, the base 16 is joined to the beams 17 and 18, and the beam 18 is joined to the bases 15 and 16. An X-axis guide 32A is disposed on the base 15, and an X-axis guide 32B is disposed on the base 16.

As in the bed 4, the bed 14 includes columns having guide structures (X-axis guides 32A and 32B) for moving the cross rail 3 parallel to a horizontal plane and perpendicular to a direction in which the saddle 2 is moved. The X-axis guides 32A and 32B are guides extending in the X direction. As the cross rail 3 moves in the X direction along the X-axis guides 32A and 32B, the machining head 1 moves in the X direction.

Note that the bed 14 and the columns may be formed separately. When the bed 14 and the columns are formed separately, the column is disposed on the upper surface of each of the bases 15 and 16. Furthermore, a reinforcing rib may be disposed inside each of the bases 15 and 16. Moreover, a reinforcing rib may be disposed inside each of the beams 17 and 18.

There is a space into which the rear end portion of the beam 17 can be inserted, on the lower side of the front end portion of the base 15. There is a space into which the rear end portion of the beam 18 can be inserted, on the lower side of the front end portion of the base 16. The rear end portion of the beam 17 is inserted into the space provided on the lower side of the front end portion of the base 15. The rear end portion of the beam 18 is inserted into the space provided on the lower side of the front end portion of the base 16. Furthermore, the upper side part of the front end portion of the base 15 is placed on the upper surface of the beam 17. The upper side part of the front end portion of the base 16 is placed on the upper surface of the beam 18.

The bed 14 has the similar structure as the bed 4 except for a joining portion where the front end portion of the base 15 and the rear end portion of the beam 17 are joined and a joining portion where the front end portion of the base 16 and the rear end portion of the beam 18 are joined.

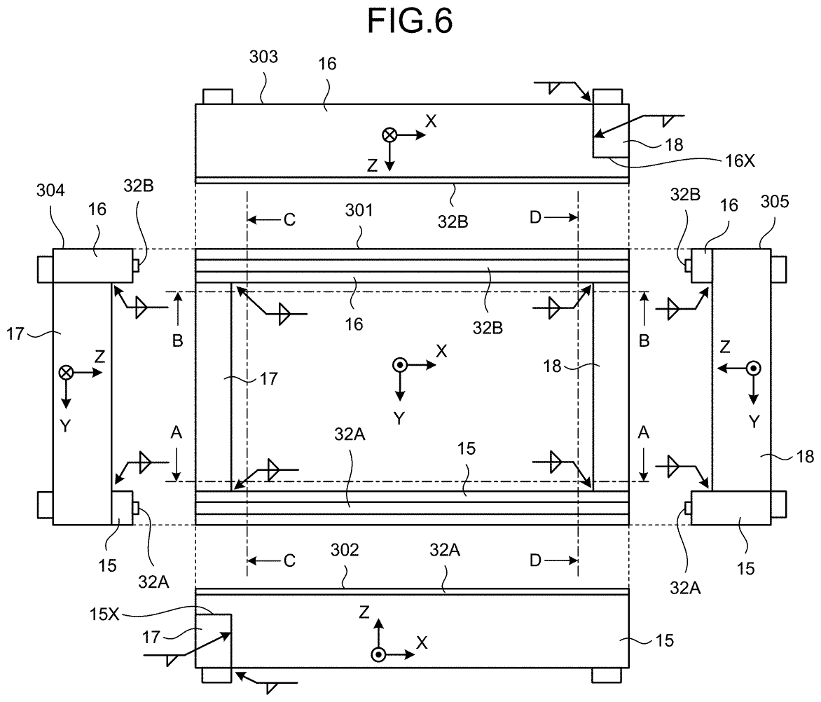

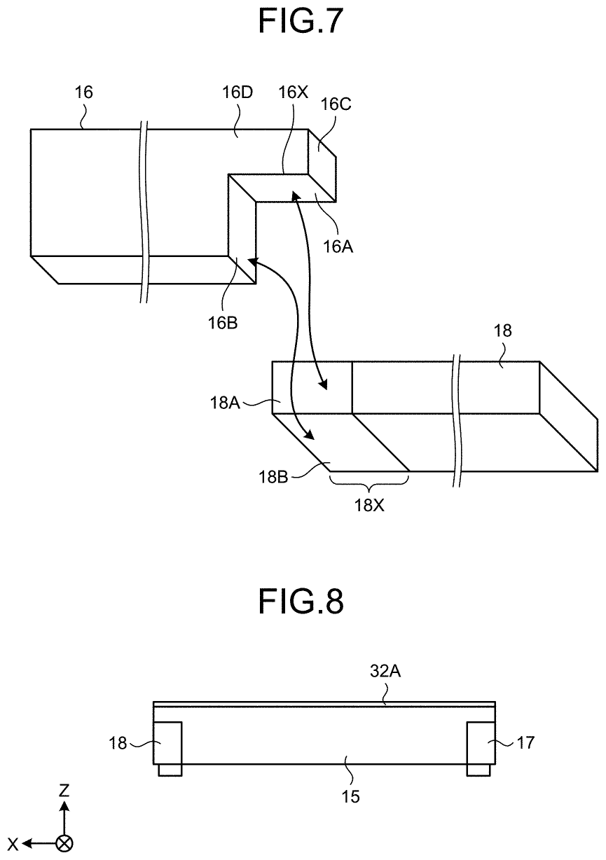

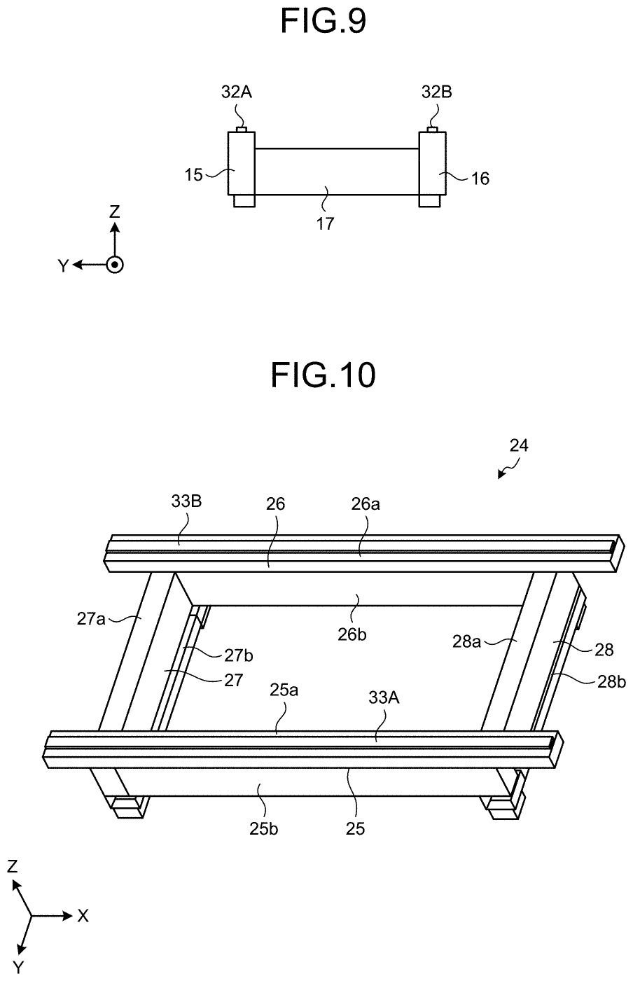

FIG. 6 is a five-view drawing illustrating the configuration of the bed included in the laser beam machine according to the second embodiment. FIG. 7 is a diagram for describing a position where the base and the beam are joined in the bed illustrated in FIG. 6. FIG. 8 is a cross-sectional view of the bed illustrated in FIG. 6, taken along line A-A. FIG. 9 is a cross-sectional view of the bed illustrated in FIG. 6, taken along line C-C. FIG. 6 illustrates a plan view 301, a front view 302, a rear view 303, a left side view 304, and a right side view 305 of the bed 14. FIG. 7 is a perspective view of the base 16 and the beam 18.

A cutout 16X is provided in a longitudinal end portion of the base 16. The rear end portion of the beam 18 can be fitted into the cutout 16X. That is, when the base 16 is viewed from the direction of a side surface 16D, the longitudinal end portion of the base 16 is L-shaped. The cutout 16X has a first surface 16A and a second surface 16B. The first surface 16A is a surface perpendicular to the side surface 16D and a front end surface 16C that is a longitudinal end surface of the base 16. The second surface 16B is a surface perpendicular to the first surface 16A and the side surface 16D. That is, the first surface 16A is a surface parallel to the upper surface and bottom surface of the base 16. The second surface 16B is a surface parallel to the front end surface 16C.

The beam 18 has a joining portion 18X to be fitted into the cutout 16X. The joining portion 18X has the same size and shape as the cutout 16X. The joining portion 18X is a longitudinal rear end portion of the beam 18. The joining portion 18X has a first surface 18A and a second surface 18B. The first surface 18A is joined to the first surface 16A. The second surface 18B is joined to the second surface 16B. The first surface 18A is the same surface as the upper surface of the beam 18. The second surface 18B is the same surface as the side surface of the beam 18.

In the bed 14, the first surface 16A and the first surface 18A are joined, and the second surface 16B and the second surface 18B are joined, so that the base 16 and the beam 18 are joined at a right angle when the bed 14 is viewed from the upper surface side.

A portion where the base 15 and the beam 17 are joined has the similar structure as the portion where the base 16 and the beam 18 are joined. Furthermore, a portion where the base 16 and the beam 17 are joined has the similar structure as the portion where the base 6 and the beam 7 are joined as described in the first embodiment. Moreover, a portion where the base 15 and the beam 18 are joined has the similar structure as the portion where the base 5 and the beam 8 are joined as described in the first embodiment. That is, the beam 18 has a front end portion joined to a side surface of the base 15, and also has a rear end portion fitted in the cutout 16X of the base 16.

Furthermore, the beam 17 has a front end portion joined to a side surface of the base 16, and also has a rear end portion fitted in a cutout 15X of the base 15. As described above, in the bed 14, the front end portion of the base 16 is joined to the upper surface and side surface of the beam 18, and the front end portion of the base 15 is joined to the upper surface and side surface of the beam 17.

In the second embodiment, the cutout 16X is joined to the side surface and upper surface of the beam 18 in the rear end side portion of the beam 18, and the cutout 15X is joined to the side surface and upper surface of the beam 17 in the rear end side portion of the beam 17. Thus, in the second embodiment, the cutout 16X is one of longitudinal end portions of the base 16, and the cutout 15X is one of longitudinal end portions of the base 15.

Note that the cross-sectional configuration of the bed 14 illustrated in FIG. 6 taken along line B-B is the similar as the cross-sectional configuration of the bed 14 illustrated in FIG. 8 taken along line A-A. The positions of the beam 17 and the beam 18 in the cross-sectional configuration of the bed 14 taken along line B-B are opposite to those in the cross-sectional configuration of the bed 14 taken along line A-A. In addition, the X-axis guide 32B is to be illustrated in the cross-sectional configuration of the bed 14 taken along line B-B, instead of the X-axis guide 32A.

Furthermore, the cross-sectional configuration of the bed 14 illustrated in FIG. 6 taken along line D-D is similar to the cross-sectional configuration of the bed 14 illustrated in FIG. 9 taken along line C-C. The positions of the base 15 and the base 16 in the cross-sectional configuration of the bed 14 taken along line D-D are opposite to those in the cross-sectional configuration of the bed 14 taken along line C-C. In addition, the positions of the X-axis guide 32A and the X-axis guide 32B in the cross-sectional configuration of the bed 14 taken along line D-D are opposite to those in the cross-sectional configuration of the bed 14 taken along line C-C. The bases 15 and 16 and the beams 17 and 18 may be joined by welding, or may be joined by other joining methods such as bolt fastening.

As described above, in the bed 14 according to the second embodiment, the front end portion of the base 15 and the side surface of the beam 17 are joined, and the front end portion of the base 16 and the side surface of the beam 18 are joined. In addition, in the bed 14, the front end portion of the beam 17 and the side surface of the base 16 are joined, and the front end portion of the beam 18 and the side surface of the base 15 are joined. Therefore, the bed 14 has rigidity similar to that of the bed 4.

Furthermore, the front end portion of the base 15 is placed on the upper surface of the beam 17, and the front end portion of the base 16 is placed on the upper surface of the beam 18. Therefore, the X-axis guides 32A and 32B can be extended to the positions of the beams 17 and 18. That is, in a case where the X-axis guides 32A and 32B equal in length to the X-axis guides 31A and 31B are placed, the span between the beams 17 and 18 can be made shorter than the span between the beams 7 and 8. As a result, since a sufficient distance to be covered by the cross rail 3 can be ensured in a space narrower than in the bed 4, it is possible to save more space than in the bed 4.

In addition, the bottom surface of the front end portion of the base 16 is placed on the upper surface of the beam 18. This facilitates position adjustment in assembling the base 16 and the beam 18. That is, since the bottom surface of the base 16 and the upper surface of the beam 18 serve as positioning faces (reference planes), it is easy to align the base 16 and the beam 18.

Similarly, the bottom surface of the front end portion of the base 15 is placed on the upper surface of the beam 17. This facilitates position adjustment in assembling the base 15 and the beam 17. That is, since the bottom surface of the base 15 and the upper surface of the beam 17 serve as positioning faces, it is easy to align the base 15 and the beam 17. Therefore, efficiency in the assembling of the bed 14 is improved.

### Third Embodiment

Next, a third embodiment of the present invention will be described with reference to FIGS. 10 to 14. In the third embodiment, a base has an upper portion and a lower portion, and a beam has an upper portion and a lower portion. As in the second embodiment, a front end portion of the base is placed on the upper surface of the beam, so that an X-axis guide is extended to the beam side.

FIG. 10 is a perspective view of a bed included in a laser beam machine according to the third embodiment, illustrating a configuration of the bed. A bed 24 includes bases 25 and 26 extending in an X direction and beams 27 and 28 extending in a Y direction.

The base 25 has a base upper portion 25a with a pillar shape and a base lower portion 25b with a pillar shape. The base upper portion 25a is an upper side part (upper portion) of the base 25, and the base lower portion 25b is a lower side part (lower portion) of the base 25. The long side of the base upper portion 25a is longer than the long side of the base lower portion 25b.

The base 26 has a base upper portion 26a with a pillar shape and a base lower portion 26b with a pillar shape. The base upper portion 26a is an upper side part of the base 26, and the base lower portion 26b is a lower side part of the base 26. The long side of the base upper portion 26a is longer than the long side of the base lower portion 26b.

The beam 27 has a beam upper portion 27a and a beam lower portion 27b. The beam upper portion 27a has a pillar shape. The beam lower portion 27b has a hollow pillar shape. The beam upper portion 27a is an upper side part of the beam 27, and the beam lower portion 27b is a lower side part of the beam 27. The beam 28 has a beam upper portion 28a and a beam lower portion 28b. The beam upper portion 28a has a pillar shape. The beam lower portion 28b has a hollow pillar shape. The beam upper portion 28a is an upper side part of the beam 28, and the beam lower portion 28b is a lower side part of the beam 28.

The beam upper portions 27a and 28a have the similar shape as the beams 17 and 18. The beam upper portion 27a is disposed at the similar position as the beam 17, and the beam upper portion 28a is disposed at the similar position as the beam 18. The base 25 is disposed at the similar position as the base 15, and the base 26 is disposed at the similar position as the base 16. That is, the bed 24 has a rectangular annular shape in which each of the bases 25 and 26 and the beams 27 and 28 serves as a side. Specifically, the base 25 is joined to the beams 27 and 28, and the beam 27 is joined to the bases 25 and 26. In addition, the base 26 is joined to the beams 27 and 28, and the beam 28 is joined to the bases 25 and 26. An X-axis guide 33A is disposed on the base 25, and an X-axis guide 33B is disposed on the base 26.

Similarly to the bed 4, the bed 24 includes columns having guide structures (X-axis guides 33A and 33B) for moving the cross rail 3 parallel to a horizontal plane and perpendicular to a direction in which the saddle 2 is moved. The X-axis guides 33A and 33B are guides extending in the X direction. As the cross rail 3 moves in the X direction along the X-axis guides 33A and 33B, the machining head 1 moves in the X direction.

The front end portion and rear end portion of the base upper portion 25a protrude outside a rectangular annular region (hereinafter, referred to as a bed annular region) surrounded by the base lower portions 25b and 26b and the beam upper portions 27a and 28a. In addition, the front end portion and rear end portion of the base upper portion 26a protrude outside the bed annular region.

Note that the bed 24 and the columns may be formed separately. When the bed 24 and the columns are formed separately, the column is disposed on the upper surface of each of the bases 25 and 26. Furthermore, a reinforcing rib may be disposed inside each of the bases 25 and 26. Moreover, a reinforcing rib may be disposed inside each of the beams 27 and 28.

A space into which the rear end portion of the beam upper portion 27a can be fitted is provided in the front end portion of the base 25. A space into which the rear end portion of the beam upper portion 28a can be fitted is provided in the front end portion of the base 26. With this configuration, the base upper portion 25a is placed on the upper surface of the beam upper portion 27a, and the base upper portion 26a is placed on the upper surface of the beam upper portion 28a.

The bed 24 has the similar structure as the bed 14 except for a joining portion where the base 25 and the beam 27 are joined, a joining portion where the base 26 and the beam 28 are joined, and the front end portions and rear end portions of the X-axis guides 33A and 33B.

When the bed 24 is produced, the base 25 having the base lower portion 25b and the base upper portion 25a is produced, and the base 26 having the base lower portion 26b and the base upper portion 26a is produced. In addition, the beam 27 having the beam lower portion 27b and the beam upper portion 27a is produced, and the beam 28 having the beam lower portion 28b and the beam upper portion 28a is produced. Then, the bases 25 and 26 and the beams 27 and 28 are assembled and joined.

The bases 25 and 26 may be formed by use of square pipes. For example, it is possible to form the base 25 by forming the base lower portion 25b and the base upper portion 25a by use of square pipes and joining the square pipes together. In addition, the beams 27 and 28 may be formed by use of square pipes. For example, it is possible to form the beam 27 by forming the beam lower portion 27b and the beam upper portion 27a by use of square pipes and joining the square pipes together. In a case where the bases 25 and 26 and the beams 27 and 28 are formed by use of square pipes, man-hours for welding can be reduced.

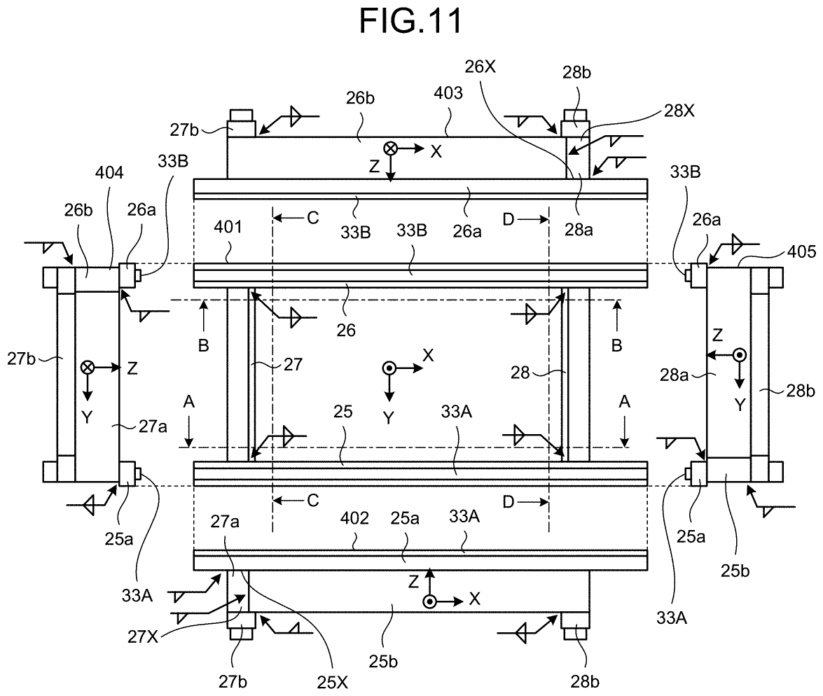

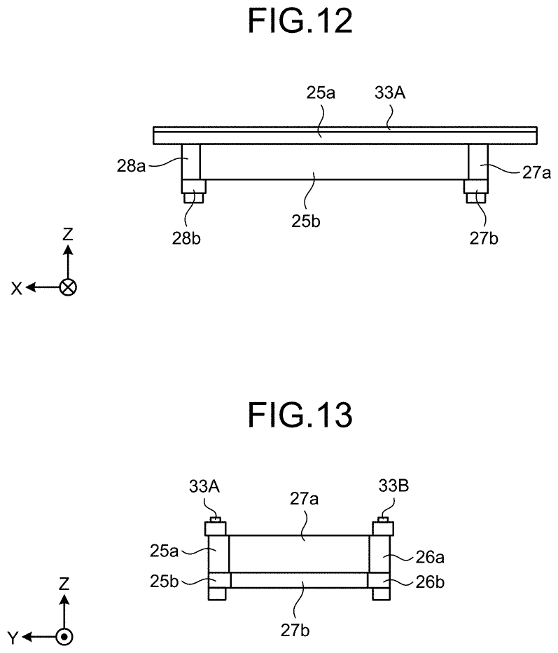

FIG. 11 is a five-view drawing illustrating the configuration of the bed included in the laser beam machine according to the third embodiment. FIG. 12 is a cross-sectional view of the bed illustrated in FIG. 11, taken along line A-A. FIG. 13 is a cross-sectional view of the bed illustrated in FIG. 11, taken along line C-C. FIG. 11 illustrates a plan view 401, a front view 402, a rear view 403, a left side view 404, and a right side view 405 of the bed 24.

Similarly to the base 16, a cutout 26X is provided in the longitudinal end portion of the base upper portion 26a. The rear end portion (joining portion 28X) of the beam upper portion 28a can be fitted into the cutout 26X. Similarly to the beam 18, the beam upper portion 28a has the joining portion 28X to be fitted into the cutout 26X. In the bed 24, the joining portion 28X is fitted into the cutout 26X. As a result, the base 26 and the beam 28 are joined at a right angle when the bed 24 is viewed from the upper surface side.

A portion where the base upper portion 25a and the beam upper portion 27a are joined also has the similar structure as the portion where the base upper portion 26a and the beam upper portion 28a are joined. Furthermore, a portion where the base upper portion 26a and the beam upper portion 27a are joined has the similar structure as the portion where the base 6 and the beam 7 are joined as described in the first embodiment. Moreover, a portion where the base upper portion 25a and the beam upper portion 28a are joined has the similar structure as the portion where the base 5 and the beam 8 are joined as described in the first embodiment. That is, the beam upper portion 28a has a front end portion joined to a side surface of the base upper portion 25a, and also has a rear end portion fitted in the cutout 26X of the base 26. In addition, the beam upper portion 27a has a front end portion joined to a side surface of the base upper portion 26a, and also has a rear end portion (joining portion 27X) fitted in a cutout 25X of the base 25. As described above, in the bed 24, the bottom surface of the front end portion of the base upper portion 26a is joined to the upper surface of the beam upper portion 28a, and the front end portion of the base lower portion 26b is joined to a side surface of the beam upper portion 28a. Furthermore, in the bed 24, the bottom surface of the front end portion of the base upper portion 25a is joined to the upper surface of the beam upper portion 27a, and the front end portion of the base lower portion 25b is joined to a side surface of the beam upper portion 27a.

With this configuration, the front end portion of the base lower portion 25b is joined to the side surface of the beam upper portion 27a and a side surface of the beam lower portion 27b. In addition, the front end portion of the base lower portion 26b is joined to the side surface of the beam upper portion 28a and a side surface of the beam lower portion 28b.

In the third embodiment, the cutout 26X is joined to the side surface and upper surface of the beam 28 in rear end side of the beam 28, and the cutout 25X is joined to the side surface and upper surface of the beam 27 in rear end side of the beam 27. Thus, in the third embodiment, the cutout 26X is one of longitudinal end portions of the base 26, and the cutout 25X is one of longitudinal end portions of the base 25.

Note that the cross-sectional configuration of the bed 24 illustrated in FIG. 11 taken along line B-B is similar to the cross-sectional configuration of the bed 24 illustrated in FIG. 12 taken along line A-A. The positions of the beam upper portion 27a and the beam upper portion 28a in the cross-sectional configuration of the bed 24 taken along line B-B are opposite to those in the cross-sectional configuration of the bed 24 taken along line A-A. Furthermore, the positions of the beam lower portion 27b and the beam lower portion 28b in the cross-sectional configuration of the bed 24 taken along line B-B are opposite to those in the cross-sectional configuration of the bed 24 taken along line A-A. In addition, the X-axis guide 33B is to be illustrated in the cross-sectional configuration of the bed 24 taken along line B-B, instead of the X-axis guide 33A.

Moreover, the cross-sectional configuration of the bed 24 illustrated in FIG. 11 taken along line D-D is similar to the cross-sectional configuration of the bed 24 illustrated in FIG. 13 taken along line C-C. The positions of the base upper portion 25a and the base upper portion 26a in the cross-sectional configuration of the bed 24 taken along line D-D are opposite to those in the cross-sectional configuration of the bed 24 taken along line C-C.

Furthermore, the positions of the base lower portion 25b and the base lower portion 26b in the cross-sectional configuration of the bed 24 taken along line D-D are opposite to those in the cross-sectional configuration of the bed 24 taken along line C-C. In addition, the positions of the X-axis guide 33A and the X-axis guide 33B in the cross-sectional configuration of the bed 24 taken along line D-D are opposite to those in the cross-sectional configuration of the bed 24 taken along line C-C.

The bases 25 and 26 and the beams 27 and 28 may be joined by welding, or may be joined by other joining methods such as bolt fastening. Furthermore, the base upper portion 25a and the base lower portion 25b may be integrally formed, or may be formed as separate members. Moreover, the base upper portion 26a and the base lower portion 26b may be integrally formed, or may be formed as separate members. In addition, the beam upper portion 27a and the beam lower portion 27b may be integrally formed, or may be formed as separate members. Furthermore, the beam upper portion 28a and the beam lower portion 28b may be integrally formed, or may be formed as separate members. Note that the base upper portion 25a may have the similar structure as the upper side part of the base 15. Furthermore, the base upper portion 26a may have the similar structure as the upper side part of the base 16.

As described above, in the bed 24 according to the third embodiment, the front end portion of the base lower portion 25b and the side surface of the beam upper portion 27a are joined, and the front end portion of the base lower portion 26b and the side surface of the beam upper portion 28a are joined. In addition, in the bed 24, the front end portion of the beam upper portion 27a and the side surface of the base lower portion 26b are joined, and the front end portion of the beam upper portion 28a and the side surface of the base lower portion 25b are joined. Therefore, the bed 24 has rigidity similar to that of the beds 4 and 14.

In addition, the X-axis guide 33A is placed on the upper surfaces of the beams 27 and 28, and the X-axis guide 33B is placed on the upper surfaces of the beams 27 and 28. Thus, similarly to the bed 14, the bed 24 can save more space than the bed 4 can.

Furthermore, similarly to the bed 14, the bottom surface of the front end portion of the base upper portion 26a is placed on the upper surface of the beam upper portion 28a, thus position adjustment in assembling the base 26 and the beam 28 is facilitated. That is, since the bottom surface of the base upper portion 26a and the upper surface of the beam upper portion 28a serve as positioning faces (reference planes), it is easy to align the base 26 and the beam 28.

Similarly, the bottom surface of the front end portion of the base upper portion 25a is placed on the upper surface of the beam upper portion 27a. This facilitates position adjustment in assembling the base 25 and the beam 27. That is, since the bottom surface of the base upper portion 25a and the upper surface of the beam upper portion 27a serve as positioning faces, it is easy to align the base 25 and the beam 27. Therefore, efficiency in the assembling of the bed 24 is improved.

The configurations set forth in the above embodiments show examples of the subject matter of the present invention, and it is possible to combine the configurations with another technique that is publicly known, and is also possible to make omissions and changes to part of the configurations without departing from the gist of the present invention.

### REFERENCE SIGNS LIST

1 machining head; 2 saddle; 3 cross rail; 4, 14, bed; 5, 6, 15, 16, 25, 26 base; 5E, 6E, 7E, 8E front end surface; 5S, 6S, 7S, 8S rear end side surface; 7, 8, 17, 18, 27, 28 beam; 15X, 16X, 25X, 26X cutout; 16A, 18A first surface; 16B, 18B second surface; 16C front end surface; 16D side surface; 18X, 27X, 28X joining portion; 25a, 26a base upper portion; 25b, 26b base lower portion; 27a, 28a beam upper portion; 27b, 28b beam lower portion; 31A, 31B, 32A, 32B, 33A, 33B X-axis guide; 35 Y-axis guide; 100 laser beam machine.

1. A laser beam machine comprising:
a processor to machine a workpiece as the processor moves;
a first movable body to hold the processor and move the processor in a first direction by moving in the first direction along a guide extending in the first direction;
a second movable body on which the first movable body is placed, the second movable body moving the first movable body and the processor in a second direction by moving in the second direction along guides extending in the second direction; and
a bed on which the second movable body is placed via the guides extending in the second direction, wherein
the bed includes pillar-shaped first to fourth members,
one of longitudinal end portions of the first member is joined to a side surface of the second member,
one of longitudinal end portions of the second member is joined to a side surface of the third member,
one of longitudinal end portions of the third member is joined to a side surface of the fourth member, and
one of longitudinal end portions of the fourth member is joined to a side surface of the first member.

2. The laser beam machine according to claim 1, wherein
a front end surface of the one of the end portions of the first member is joined to a rear end side portion of the side surface of the second member, and
a front end surface of the one of the end portions of the third member is joined to a rear end side portion of the side surface of the fourth member.

3. The laser beam machine according to claim 1, wherein
a first cutout is formed in the one of the end portions of the first member,
the first cutout is joined to the side surface and an upper surface of the second member in rear end side portion of the second member,
a second cutout is formed in the one of the end portions of the third member,
the second cutout is joined to the side surface and an upper surface of the fourth member in rear end side portion of the fourth member, and
the guide extending in the first direction is placed on an upper surface of the first member and an upper surface of the third member.

4. The laser beam machine according to claim 1, wherein
the first member has a first upper portion and a first lower portion,
the first upper portion longitudinally extends beyond both longitudinal end portions of the first lower portion,
one of the longitudinal end portions of the first lower portion is joined to the side surface of the second member,
the first upper portion is supported by the first lower portion, the second member, and the fourth member,
the third member has a second upper portion and a second lower portion,
the second upper portion longitudinally extends beyond both longitudinal end portions of the second lower portion,
one of the longitudinal end portions of the second lower portion is joined to the side surface of the fourth member,
the second upper portion is supported by the second lower portion, the second member, and the fourth member, and
the guide extending in the first direction is placed on an upper surface of the first upper portion and an upper surface of the second upper portion.

5. The laser beam machine according to claim 1, wherein
the processor is a machining head to irradiate the workpiece with a laser beam.

6. The laser beam machine according to claim 1, wherein
the second movable body is a cross rail movable in the first direction in a horizontal plane, and
the bed includes a column to cause the cross rail to move in the second direction in the horizontal plane.

7. The laser beam machine according to claim 1, wherein
the first to fourth members are formed by use of square pipes.

8. The laser beam machine according to claim 7, wherein
a reinforcing rib is disposed inside each of the first to fourth members.
